(19) United States
(12) Patent Application Publication
(10) Pub. No.: US 2017/0032389 A1
(43) Pub. Date: Feb. 2, 2017

(54) SYSTEM AND METHOD FOR CONDUCTING NON-NOUISANT SURVEYS OVER VIRTUAL NETWORKS

(71) Applicant: International Business Machines Corporation, Armonk, NY (US)

(72) Inventors: Genady Grabarnik, Scarsdale, NY (US); Dimitri Kanevsky, Ossining, NY (US); Mark E. Podlaseck, Kent, NY (US); Larisa Shwartz, Scarsdale, NY (US)

(73) Assignee: International Business Machines Corporation, Armonk, NY (US)

(21) Appl. No.: 15/294,943

(22) Filed: Oct. 17, 2016

Related U.S. Application Data
(62) Division of application No. 12/621,488, filed on Nov. 18, 2009.

(51) Int. Cl. G06Q 30/02; G09B 7/00; G06N 3/00

(52) U.S. Cl. CPC G06Q 30/0201; G06Q 30/0207; G06N 3/008; G09B 7/00

(57) ABSTRACT

A polling method, online polling system and program product therefor. A system avatar unit creates, maintains and controls system avatars distributed throughout a virtual world. System avatars receive questions received from polling system clients. A dialogue module manages dialogs between system avatars presenting the questions to user avatars in the virtual world. A report generator generates reports responsive to responses given by user avatars to system avatars.

### CROSS REFERENCE TO RELATED APPLICATION

The present invention is a divisional application of U.S. patent application Ser. No. 12/621,488 (Attorney Docket No. YOR920080604US1), “SYSTEM AND METHOD FOR CONDUCTING NON-NOUISANT SURVEYS OVER VIRTUAL NETWORKS” to Genady Grabarnik et al., filed Nov. 18, 2009, assigned to the assignee of the present invention and incorporated herein by reference.

### FIELD OF THE INVENTION

The present invention generally relates to systems and methods of conducting surveys and polling users.

### BACKGROUND DESCRIPTION

Currently, polling companies and organizations use pop-ups, spam e-mail, and online surveys to conduct polls and surveys over the Internet. Because a pop-up can direct one to a potentially hazardous web site and because pop-ups have become so prevalent as to interfere with normal browsing, state of the art browsers usually include a pop-up blocker capability. A pop-up blocker can prevent survey questions from ever reaching potential poll participants, even participants that might otherwise want to participate in a particular poll. Several Internet security application providers have developed spam filters that intercept suspected spam, often before it enters one's inbox. Bypassing these safeguards to participate in a particular poll often requires a user to take extra steps to defeat/bypass the safeguards, and take extra time to complete a survey.

Consequently, polling companies and organizations that conduct on-line, interactive polls and surveys, e.g., over the Internet, frequently are required to offer incentives to entice users through these counter-measures to encourage users to complete surveys. These incentives add extra costs to the surveying process. Even with appropriate incentives conducting on-line polls through virtual networks present potential poll takers with a nuisance the potential poll taking Internet users would likely rather avoid.

Thus, there is a need for conducting online surveys and polling users that does not detract from the user's online experience, such that polling companies and organizations may save money and avoid offering incentives to willing users completing the surveys.

### SUMMARY OF THE INVENTION

It is a purpose of the invention to facilitate online polling and surveys;

It is another purpose of the invention to conduct online polling and surveys without detracting from online experience of users taking the poll/survey;

It is yet another purpose of the invention to encourage willing participation in online polls and surveys.

The present invention relates to a polling method, online polling system and program product therefor. A system avatar unit creates, maintains and controls system avatars distributed throughout a virtual world. System avatars receive questions received from polling system clients. A dialogue module manages dialogs between system avatars presenting the questions to user avatars in the virtual world. A report generator generates reports responsive to responses given by user avatars to system avatars.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a system 100 for conducting on-line surveys and polling users according to a preferred embodiment of the present invention;

FIG. 2 shows an example of creating surveys and polling users, even distant users, through virtual networks without interfering with or, detracting from, each individual user's online experience;

FIG. 3 shows an example of generating surveys/questionnaires and presenting those surveys/questionnaires to users through UCAs.

### DESCRIPTION OF PREFERRED EMBODIMENTS

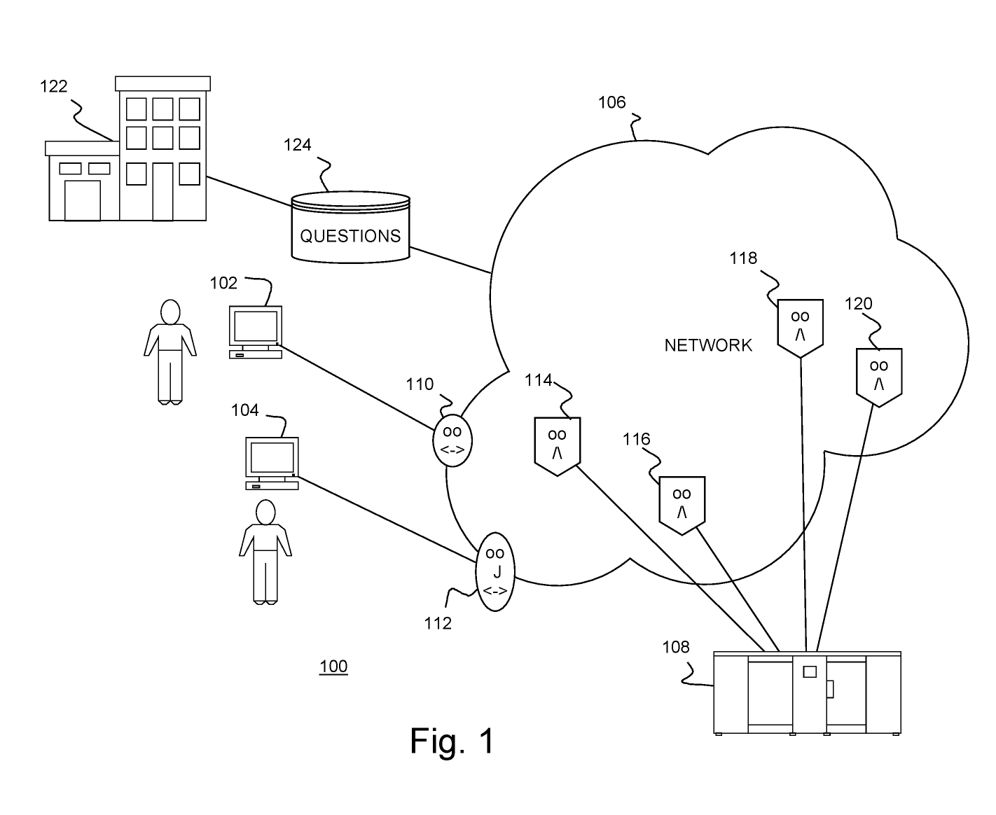

Turning now to the drawings and, more particularly, FIG. 1 shows an example of a system 100 for conducting online surveys and polling users according to a preferred embodiment of the present invention. User devices 102, 104 are connected, e.g., over a network/virtual world 106, to a preferred Virtual Avatar Polling System (VAPS) 108, e.g., in a remote server. Each user creates, owns and maintains a system presence, e.g., avatars 110, 112, in the virtual world 106. User avatars 110, 112 also are referred to herein as User Controlled Avatars (UCAs). The VAPS 108 creates, maintains and controls several system avatars, 114, 116, 118, 120, in the virtual world 106. These system avatars, 114, 116, 118, 120 also are referred to herein as VAPS Controlled Avatars (VCAs). A business/client 122 provides questions, e.g., in the form of a questionnaire 124, to VAPS 108 for presenting to users, e.g., in online surveys and polling users. Typically, the system includes multiple businesses/clients 122, each providing one or more questionnaires 124. The VCAs 114, 116, 118, 120 present the questions to UCAs 110, 112 as they encounter each other in the virtual world 106. Thus, a preferred VAPS 108 performs randomized polling in conversational based virtual interaction.

Each user has an avatar (UCA 108, 110), a virtual character, that they can navigate through the virtual world. Avatars are commonly used in video gaming, e.g. the Wii™ from Nintendo® and the XBOX Live from Microsoft® Corporation. In interactive video gaming on-line users compete over a network such as the Internet. In Second Life®, for example, each user controls an avatar that may interact freely with other avatars in a virtual world. As each user joins the system, the user creates his/her own UCA 108, 110 as a virtual presence within the system. The VAPS 108 allows client organizations 122 to poll users using suitable artificial intelligence communication technology (e.g., neural nets or statistical models that based on Hidden Markov models or Bayesian networks), virtually embodied as system avatars. Thus, the VAPS 108 maintains virtual presences on the system through VCAs 114, 116, 118, 120, that interact with the UCAs 110, 112. The VCAs 114, 116, 118, 120 are randomly distributed throughout the virtual world 106 and interact with UCAs 110, 112 at a predetermined rate. Thus, the randomly distributed VCAs 114, 116, 118, 120 perform random single polling events throughout each user's session unobtrusively polling the users during the session.

A client company 122 creates a series of questions 124 as, for example, a questionnaire 124 that the client company 122 wishes answered by the public. The client company 122 submits the questions 124 over the network 106 to VAPS 108. The VAPS 108 designates a VCA, e.g., 116, or multiple VCAs to interact with UCAs 110, 112, collecting answers to the questions 124. The VCAs 114, 116, 118, 120 may be programmed to question the UCAs 110, 112, e.g., marketing, business, scientific, and public safety questions 124. Thus, the VAPS 108 systematically poses the questions 124 using the various VCAs 114, 116, 118, 120 that interact with UCAs 110, 112, seamlessly and hidden to the user without the user being aware in some cases that his/her responses are being collected. The VAPS 108 also can create dynamic surveys where in one virtual world session, UCAs 110, 112 can interact with many different VCAs 114, 116, 118, 120 answering multiple questions that are related to the same poll or survey.

Questions may be formulated to appear as part of a general conversation or related to some aspect of the virtual world, while masking the true intent of the question and data being collected. For example, VAPS 108 may be collecting information regarding one of two candidates X and Y for which UCA users would vote. The VCAs 114, 116, 118, 120 do not ask directly each UCA's preference. Instead, one VCA 114, 116, 118, 120 tells a story. The story may indicate that the watched TV debates between X and Y. Then, after the story, the VCA may follow with something like “I liked how X performed more than Y,” and ask the UCA how it liked how candidate X performed. The UCA may respond saying, “I think Y made better points” and/or “Y was more presidential.” The VCA follows up with “do you think you would vote Y because he performed better on TV?” By asking these indirect questions, the VCA masks the questioning which appears as part of common conversation rather than polling.

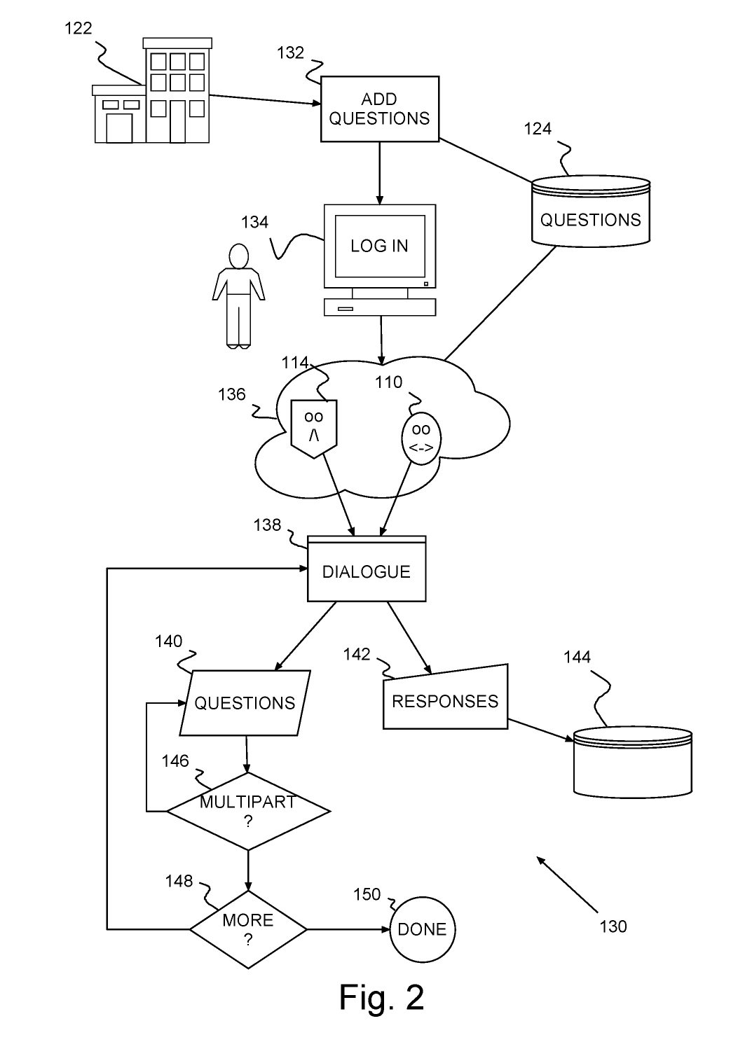

FIG. 2 shows an example 130 of creating surveys and polling users, even distant users, through virtual networks without interfering with or, detracting from, each individual user's online experience with reference to the preferred system of FIG. 1. This example begins in 132 when a client company 122 independently creates questions 124 for a survey to be implemented by VAPS 108 through VCAs 114, 116, 118, 120. At some point in 134 a user logs into their avatar or creates a new avatar, e.g., UCA 110, and navigates a virtual world. It should be noted that questions may be created/provided 132 before, after, or simultaneously with, a user logging in 134. A preferred system 100 may be used, for example, for questioning patient users, and especially, questioning elderly patients on different subjects. Questioning may be conducted over a virtual network(s), using the patient's answers to make initial estimates of the patient's mood or state of mind.

When a user logs in 134, one of the VCAs, e.g., 116, approaches 136 that user's UCA, e.g., 110. In the virtual world, the VCAs 114, 116, 118, 120 appear no different than the UCAs 110, 112. The avatars, 110 and 116 in this example, converse normally, carrying on a dialogue 138 that is no different than a dialogue between two UCAs 110, 112. During the dialogue 138, the VCA 116 poses a question or questions 140 to UCA 110. Optionally, pollster users can enter the virtual world logging in 134, e.g., as UCA 112. Once logged in the, UCA 112 can scan user profiles, e.g., stored in storage 124, for the UCAs of people that match criteria of interest. Once a matching UCA is found, e.g., 110, the pollster UCA 112 teleports itself to online matching UCA 110 and unobtrusively questions the UCA 110.

In another example, a VCA 116 may ask “Who do you think should be president, Hillary Clinton or Barack Obama?” The UCA 110 responds 142 to the polling question The VCA 116 logs the response 142, and stores 144 logged responses. Responses may be stored 144 locally in the VAPS 108 or remotely, e.g., in the storage 122 with the questions. For multipart questions or questions that depend on a previous response, the response to the current question (e.g., “Did you vote in the last election?”) can terminate the line of questioning or lead to a number of other subsequent follow up questions. In 146 the VAPS 108 decides whether to direct the VCA 110 to the next follow up question. Once the dialogue is complete 148, the conversation terminates 150.

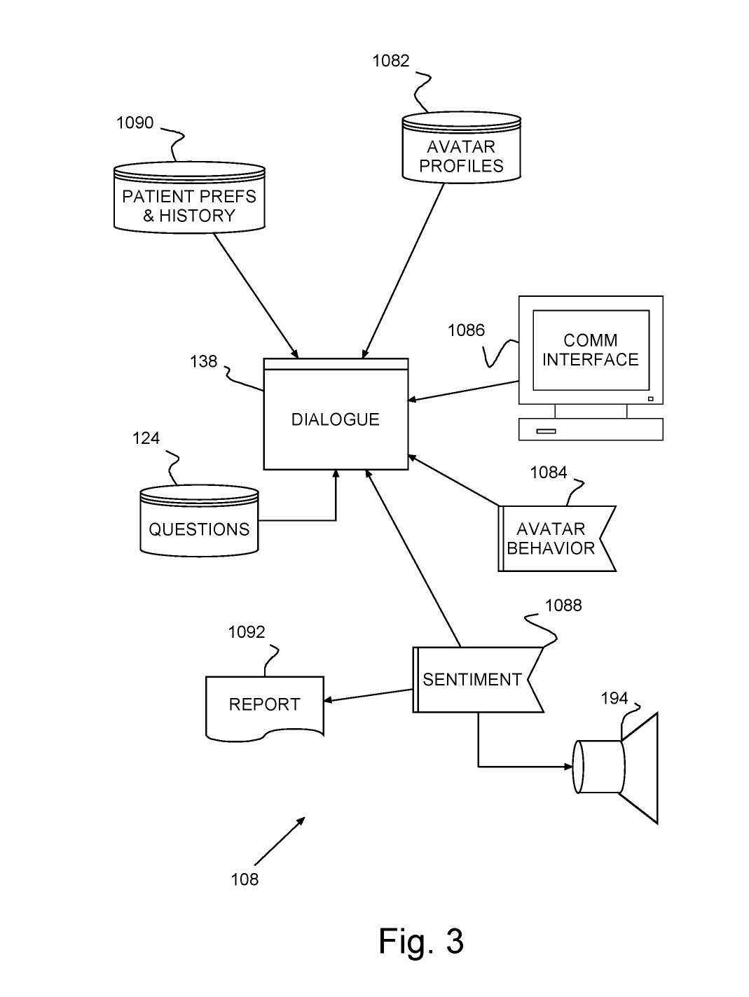

FIG. 3 shows an example of a system 108 for generating surveys/questionnaires 124 and presenting those surveys/questionnaires 124 to users through UCAs 110, 112 according to a preferred embodiment of the present invention with reference to FIG. 1 and FIG. 2. The ordering company 110 sends a survey questionnaire 124 to system dialog module 138, e.g., logging in to add questions 132. The system dialog module 138 accesses an avatar profile database 1082 and chooses one or more VCAs 114, 116, 118, 120 according community group questioned and appropriate virtual incentives. An avatar behavior interpreter 1084 sends the selected avatar(s) 114, 116, 118, 120 to browse for UCAs 110, 112 belonging to the targeted community group and, based on the avatar behavior, identifies appropriate group members. Since the questions are targeted to identified group members, frequently, the same questions are not presented to all UCAs 110, 112. Thus, disinterested or otherwise untargeted UCAs 110, 112 are not bothered by otherwise irrelevant questions. Upon establishing contact the selected avatar(s) 114, 116, 118, 120 communicate through communication interface 1086 with identified UCAs 110, 112 to explain incentives and conduct the survey.

As the selected system avatar(s) 114, 116, 118, 120 communicate through communication interface 1086 with identified UCAs 110, 112, a sentiment interpreter 1088 may monitor UCA answers, e.g., on general mood to determine UCA sentiment. Where the user is a patient, for example, the sentiment interpreter 1088 may monitor possible pain or discomfort indicators. Optionally, the system dialog module 138 may also maintain a patient database 1090 of patients' history and preferences. Preferably, the patient database 1090 also identifies avatar schedules and profiles, matched to visits. Dialog results (e.g., 142 in FIG. 2) may be provided the form of report 1092 and/or alarm 1094.

Advantageously, the preferred VAPS 108 facilitates creating online surveys and polling users through virtual networks without detracting from the users' online experiences. Because the users' online experiences are not degraded, companies and organizations may find it unnecessary to offer incentives to encourage users to complete online surveys, thus saving money for these organizations. Further, pollsters and testing organizations have access to secure virtual profile(s) in a virtual world populated by residents that are potential customers. Pollsters can enter the virtual world, scan user profiles for the UCAs of people that match criteria of interest, teleport themselves (VCAs or UCAs) to online matching people and unobtrusively question the UCAs of those matching people. Preferably, questioning avatars is based on user profile preferences or optimization based on user classification.

Moreover, questioning patients (or elderly or their avatars) on different subjects may be conducted over virtual networks, with the responses/answers providing a basis for making initial estimates of the patients' mood or state. Thus, the VCAs can detect and monitor minor patient discomforts, for example, even those where the person does not think the discomfort is worth it to go to the doctor. Thus, a preferred system facilitates creating surveys and polling users through virtual networks without detracting from individual user's online experience and that allows companies and organizations to save money by not having to offer incentives for users to complete surveys.

While the invention has been described in terms of preferred embodiments, those skilled in the art will recognize that the invention can be practiced with modification within the spirit and scope of the appended claims. It is intended that all such variations and modifications fall within the scope of the appended claims.

What is claimed is:

1. A polling system comprising:
questionnaire storage storing questions received from polling system clients for presentation to system users;
avatar storage storing avatar profiles for each of said system users;
a system avatar unit creating, maintaining and controlling a plurality of system avatars;
a dialogue module managing dialogs between said plurality of system avatars and user avatars in a virtual world, said virtual world including a user avatar for each active system user, said system avatars being distributed throughout said virtual world; and
a report generator generating reports responsive to user responses from user avatars to said system avatars.

2. A polling system as in claim 1, further comprising:
a profile scanner selectively scanning user avatar profiles for the user avatars of users matching identified criteria of interest, wherein said means for scanning scans responsive to selected users logging in; and
a virtual teleporter teleporting avatars for each logged in selected user to online matching user avatars, the teleported user avatar unobtrusively questioning respective identified matching user avatars at the user avatar location in the virtual world.

3. A polling system as in claim 1, wherein said dialogue module collects said responses and processes said collected responses.

4. A polling system as in claim 3, further comprising a user avatar behavior interpreter selecting user avatars for questioning based on said user avatar behavior.

5. A polling system as in claim 4, further comprising a user avatar sentiment interpreter interpreting user mood from sentiment in said collected responses.

6. A polling system for polling medical patients as in claim 3, further comprising a patient history and presence database, said system avatars identifying user avatars for presenting questions responsive to patient history and presence.

7. A polling system as in claim 1, wherein said dialogue module selectively engages system avatars in conversation with user avatars, questions being presented in said conversation and said report generator selectively generates an alarm.

8. A computer program product for conducting on-line polls and surveys, said computer program product comprising a non-transitory computer usable medium having computer readable program code stored thereon, said computer readable program code comprising:
computer readable program code configured to store lists of system client questions;
computer readable program code configured to store profiles of user avatars;
computer readable program code configured to randomly distribute a plurality of system avatars throughout a virtual world, the distributed system avatars being artificial intelligence (AI) avatars;
computer readable program code configured to allow entry by one or more said user avatars into said virtual world;
computer readable program code configured to select ones of said plurality of system avatars for presenting questions to each user avatar, a system dialogue module selecting said ones;
computer readable program code configured to send said ones to locate said each user avatar, an avatar behavior interpreter sending said ones, said one or more user avatars being under control of respective system users;
computer readable program code configured to engage each user avatar in conversation upon an encounter with each of said system avatars, wherein said conversation is a general conversation or related to an aspect of said virtual world;
computer readable program code configured to select and pose a subset of said system client questions from said lists by a respective system avatar in said conversation, wherein questions from each list are spread amongst said plurality of system avatars and each list is presented to selected user avatars in conversation unobtrusively and seamlessly such that said all listed questions are scattered throughout said virtual world and masked in said conversation, whereby masked questions appear as part of conversation rather than polling;
computer readable program code means configured to collect from each user avatar responses to each of said questions to each said respective system avatar and to process collected responses; and
computer readable program code means configured to generate reports from processed responses, wherein avatar users remain unaware that responses are being collected for unobtrusively posed questions, whereby inducements to encourage system users to answer masked questions are unnecessary.

9. A computer program product for conducting on-line polls and surveys as in claim 8, said system dialogue module further maintaining a user avatar profile database of user avatars for previously logged in users.

10. A computer program product for conducting on-line polls and surveys as in claim 8, further comprising:
computer readable program code configured to interpret user mood from avatar behavior and selectively identify user avatars for questioning based on interpreted said user mood; and
computer readable program code configured to detect and monitor system user sentiment from said user mood responsive to presented said client questions.

11. A computer program product for conducting on-line polls and surveys as in claim 8, further comprising:
computer readable program code configured to scan user avatar profiles for the user avatars of users matching identified criteria of interest;
computer readable program code configured to teleport avatars to online matching user avatars and question the matching user avatars.

12. A computer program product for conducting on-line polls and surveys as in claim 8, wherein the computer readable program code configured to randomly distribute system avatars comprises computer readable program code configured to distribute stored system client questions from said lists for each system client amongst said randomly distributed system avatars.

13. A computer program product for conducting on-line polls and surveys as in claim 12, wherein said subset is one listed question and the computer readable program code configured to distribute stored system client questions distributes all questions for said each system client amongst said randomly distributed system avatars.

14. A computer program product for conducting on-line polls and surveys as in claim 10, wherein interpreting user mood detects user discomfort or pain.

15. A computer program product for conducting on-line polls and surveys as in claim 8, wherein the computer readable program code configured to generate reports selectively causes an alarm to be generated.

16. A system for collecting information from users comprising:
question input means for receiving lists of questions from system clients for presentation to system users;
virtual world means for presenting a virtual world to said system users;
virtual world entry means for logging into said virtual world by one or more said system users;
user avatar creation means for creating and maintaining an avatar in said virtual world for each said one or more said system users;
system avatar creation means for creating and maintaining artificial intelligence (AI) avatars as system avatars in said virtual world;
avatar behavior interpreter means for sending said system avatars into said virtual world, said system avatars being distributed randomly throughout said virtual world such that user avatars navigating through said virtual world encounter said system avatars, wherein upon an encounter each system avatar engages the respective user avatar in conversation, said conversation being a general conversation or related to an aspect of said virtual world;
system dialog means for choosing ones of distributed said system avatars for presenting client questions in said conversation, in each list of questions different ones of said client questions being presented to said user avatars by different ones of said system avatars as each user avatar encounters said different ones such that questions from said each list are scattered throughout said virtual world and masked in the conversations, whereby masked questions appear as part of the conversation rather than client questions, and inducements to encourage system users to answer masked questions are unnecessary; and
report generation means for generating reports responsive to responses given by user avatars to system avatars.

17. A system as in claim 16, wherein
said system dialog means comprises:
avatar profile maintenance means for maintaining a user avatar profile database, and
means for scanning user avatar profiles for user avatars matching identified criteria of interest; and
said system further comprises:
avatar teleporting means for teleporting avatars to online matching user avatars, teleported said avatars questioning matching user avatars, wherein said means for scanning scans responsive to selected client users logging in and teleports the respective user avatar for the selected client user to an online matching user avatar location in the virtual world.

18. A system as in claim 16, wherein
said system dialog means comprises means for collecting responses and processing collected responses; and
said avatar behavior interpreter means comprises means for interpreting avatar user mood and detecting user discomfort and further comprises means for monitoring detected user discomfort and pain.

19. A system as in claim 18, wherein the chosen said system avatars engage in said conversation with user avatars, engaged said system avatars presenting listed questions seamlessly and unobtrusively to the avatar user such that the avatar user remains unaware that question responses are being collected.

20. A system as in claim 16, further comprising a user history and presence database, said system avatars identifying user avatars for presenting a respective client user's questions responsive to user history and presence.
